(19) United States
(12) Patent Application Publication
(10) Pub. No.: US 2016/0108204 A1
(43) Pub. Date: Apr. 21, 2016

(54) Transient Liquid Phase Compositions Having Multi-Layer Particles

(71) Applicants: Toyota Motor Engineering & Manufacturing North America, Inc., Erlanger, KY (US); Toyota Jidosha Kabushiki Kaisha, Aichi-ken (JP)

(72) Inventors: Shailesh N. Joshi, Ann Arbor, MI (US); Takehiro Kato, Miyoshi (JP); Ercan M. Dede, Ann Arbor, MI (US); Kyosuke Miyagi, Ann Arbor, MI (US)

(73) Assignees: Toyota Motor Engineering & Manufacturing North America, Inc., Erlanger, KY (US); Toyota Jidosha Kabushiki Kaisha, Aichi-ken (JP)

(21) Appl. No.: 14/517,098

(22) Filed: Oct. 17, 2014

(51) Int. Cl. C08K 3/08

(52) U.S. Cl. CPC C08K 3/08; C08K 2003/085

(57) ABSTRACT

Transient liquid phase compositions and bonding assemblies are disclosed. In one embodiment, a transient liquid phase composition includes a plurality of particles. Each particle includes a core, an inner shell surrounding the core, the inner shell, and an outer shell surrounding the inner shell. The core is made of a first high melting temperature material, the inner shell is made of a second high melting temperature material, and the outer shell is made of a low melting temperature material. The melting temperature of the low melting temperature material is less than the melting temperature of both the first and second high melting temperature materials.

### TECHNICAL FIELD

The present specification generally relates to transient liquid phase compositions and, more particularly, to transient liquid phase compositions having multi-layered particles with a high melting temperature core to tune the mechanical properties of a resulting bond.

### BACKGROUND

Power semiconductor device, such as those fabricated from silicon carbide, may be designed to operate at very high operating temperatures (e.g., greater than 300° C.). Such power semiconductor devices may be bonded to a cooling device, such as heat sink or a liquid cooling assembly, for example. The cooling device removes heat from the power semiconductor to ensure that it operates at a temperature that is below its maximum operating temperature. The bonding layer that bonds the power semiconductor device to the cooling device must be able to withstand the high operating temperatures of the power semiconductor device.

Transient liquid phase bonding results in a bond layer having a high temperature melting point. A typical transient liquid phase bond consists of two different material compounds: a metallic layer and an intermetallic layer or alloy. Generally, the intermetallic layer or alloy is formed during an initial melting phase wherein a low melting temperature material, such as tin, diffuses into a high melting temperature material, such as copper or nickel. Although the intermetallic alloy has a high re-melting temperature, it is also brittle (i.e., has a low elastic modulus) and can cause premature fracture of the bond at high temperature. The brittle property of the intermetallic alloy is not desirable for successful operation of the bond at high operating temperatures and thermal stresses.

Accordingly, a need exists for alternative compositions for forming a bonding layer capable of withstanding high temperatures.

### SUMMARY

In one embodiment, a transient liquid phase composition includes a plurality of particles. Each particle includes a core, an inner shell surrounding the core, and an outer shell surrounding the inner shell. The core is made of a first high melting temperature material, the inner shell is made of a second high melting temperature material, and the outer shell is made of a low melting temperature material. The melting temperature of the low melting temperature material is less than the melting temperature of both the first and second high melting temperature materials.

In another embodiment, a bonding assembly includes a metal foil and a transient liquid phase composition. The metal foil has a first surface and a second surface and is made of tin. The transient liquid phase composition includes a plurality of particles that is disposed in the first surface and/or the second surface of the metal foil. Each particle includes a core, an inner shell surrounding the core, and an outer shell surrounding the inner shell. The core is made of a first high melting temperature material, wherein the first high melting temperature material is nickel, silver, copper, or aluminum. The inner shell is made of a second high melting temperature material, wherein the second high melting temperature material of the inner shell is nickel or silver. The outer shell is made of tin.

In yet another embodiment, a composition includes a plurality of first particles and a plurality of second particles. Each first particle includes a core made from a first metal, and a shell surrounding the core, wherein the shell is a polymer material. Each second particle is a second metal, wherein a melting point temperature of the first metal is greater than a melting point temperature of the second metal.

These and additional features provided by the embodiments described herein will be more fully understood in view of the following detailed description, in conjunction with the drawings.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1 schematically depicts a plurality of particles of an example transient liquid phase composition according to one or more embodiments described and illustrated herein;

FIG. 2 schematically depicts a plurality of first particles and a plurality of second particles of another example transient liquid phase composition according to one or more embodiments described and illustrated herein;

FIG. 3 schematically depicts a plurality of first particles and a plurality of second particles of a composition, wherein the first particles include a polymer outer shell, according to one or more embodiments described and illustrated herein;

FIG. 4A schematically depicts a top or bottom view of an example bonding assembly comprising a plurality of particles embedded in a metal foil according to one or more embodiments described and illustrated herein;

FIG. 4B schematically depicts a side view of the example bonding assembly depicted in FIG. 4A according to one or more embodiments described and illustrated herein;

FIG. 5 schematically depicts an example process for fabricating the bonding assembly depicted in FIGS. 4A and 4B according to one or more embodiments described and illustrated herein; and

FIG. 6 schematically depicts a power semiconductor device assembly including a bonding layer according to one or more embodiments described and illustrated herein.

### DETAILED DESCRIPTION

Referring generally to the figures, embodiments of the present disclosure are directed to compositions and assemblies comprising a low melting temperature material and a high melting temperature material, which may be used in bonding applications, such as solder applications or transient liquid phase bonding applications. In some embodiments, a combination of materials are utilized that provide for the advantages of transient liquid phase bonding, such as low melting temperature, higher re-melt temperature, high yield strength, and medium thermal conductivity along with improved mechanical properties of the bond, such as ductility of the bond layer. Embodiments utilize particles comprising a core and one or more shell layers to alter the mechanical property of the bond layer.

The multi-layered coatings may be created by applying one or more coating layers on a high melting temperature core material. The core material provides the desired mechanical property at a high temperature, such as the operating temperature of a power semiconductor device (e.g., a SiC power semiconductor device). Generally, the outermost shell layer is made of tin or similar material because tin has a lower melting point (i.e., lower processing temperature) and has higher diffusivity into high melting temperature materials, such as copper and nickel. As described in more detail below, the thickness of the coating layer(s) (e.g., outer shell layer(s)) may vary depending upon the percent weight of the high melting temperature material, such as copper or nickel. Embodiments may also utilize shell layers fabricated from a polymer material to achieve desired mechanical properties of the bond layer Embodiments described herein also may incorporate a metal foil having the multi-material particles disposed therein.

Various embodiments of transient liquid phase compositions, compositions, and bonding assemblies are described in detail herein.

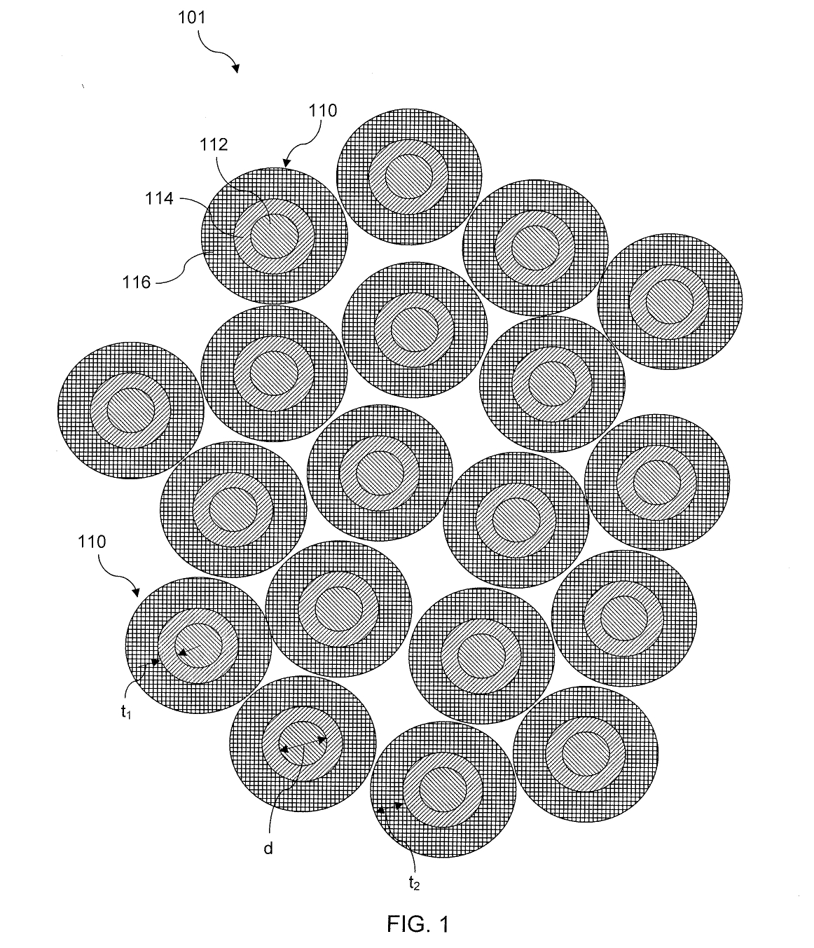

Referring now to FIG. 1, a schematic, enlarged view of a transient liquid phase composition 101 comprising a plurality of particles 110 shown in cross-section is illustrated. The particles 110 of the illustrated embodiment are configured as ternary particles comprising a core 112 made of a first high melting temperature material, an inner shell 114 made of a second high melting temperature material, and an outer shell 116 made of a low melting temperature material. It should be understood that not all of the particles 110 are numbered for clarity and ease of illustration. It should also be understood that the particles may not be spherical in shape, and that they may take on arbitrary shapes. Although the particles of the compositions are described in the context of bonding, the use of such particles is not limited thereto. For example, the particles described herein may be implemented in a composite material application.

The low melting temperature material of the outer shell 116 has a melting temperature that is lower than that of the first and second high melting temperature materials of the core 112 and the inner shell 114, respectively. Accordingly, the embodiment depicted in FIG. 1 provides for a multi-layered, ternary transient liquid phase composition 101 wherein the individual particles 110 bond with each other by diffusion of the low temperature melting material of the outer shell 116 into the high temperature melting material of the inner shell 114, which creates a high-temperature intermetallic alloy.

The example transient liquid phase composition 101 illustrated in FIG. 1 provides for a composition that has a re-melting temperature that is greater than the initial melting temperature. As an example and not a limitation, the initial melting temperature (e.g., the bonding process temperature) may be less than about 250° C., while the re-melting temperature (e.g., a maximum operating temperature for a power semiconductor device bonded by the transient liquid phase composition) may be significantly higher.

The plurality of particles 110 may be configured as loose particles in the form of a powder. In other embodiments, the plurality of particles 110 may be configured as a paste, wherein the plurality of particles 110 is disposed in an inorganic binder.

Example first high temperature materials for the core 112 include, but are not limited to, nickel, silver, copper and aluminum. Example second high temperature materials for the inner shell 114 include, but are not limited to, nickel or silver. It should be understood that the same material should not be chosen for both the core 112 and the inner shell 114. As a non-limiting example, the low melting temperature material of the outer shell 116 may be tin or indium.

Any known or yet-to-be-developed technique may be utilized to fabricate the particles 110 described herein. As non-limiting examples, the particles (e.g., particles 110) described herein may be fabricated from electroplating, electroless plating, and other water-based processes.

The material for the core 112 may be chosen to achieve desirable mechanical properties of the resulting bond following the initial melting of the transient liquid phase composition 101. For example, the material for the core 112 may be chosen to increase the ductility of the resulting bond layer, thereby resulting in a less brittle bond. Accordingly, the transient liquid phase compositions described herein may be useful in power electronics applications (e.g., to bond a power semiconductor device to a cooling assembly in an inverter circuit of a hybrid or electric vehicles) because they have a high operating temperature (e.g., greater than 450° C.) and have a ductility (i.e., softness) comparable to traditional tin-based solder. It should be understood that the compositions described herein may be utilized in applications other than power electronics applications, and may be used to bond any two components together.

In one non-limiting example, the core 112 is made from aluminum, the inner shell 114 is made from nickel, and the outer shell 116 is made from tin. In another non-limiting example, the core 112 is made from copper, the inner shell 114 is made from nickel, and the outer shell is made from tin. In yet another non-limiting example, the core 112 is made from copper, the inner shell 114 is made from silver, and the outer shell 116 is made from tin.

The percent weight of the low melting temperature material of the outer shell 116 of the transient liquid phase composition 101 may be chosen to achieve desired mechanical properties as well as a re-melting temperature of the intermetallic compound after the initial melting process. The desired percent weight of the low melting temperature material may be achieved by selecting the diameter and thicknesses of the core 112, the inner shell 114 and the outer shell 116. Referring to FIG. 1, the core 112 has a diameter d, the inner shell 114 surrounding the core 112 has a thickness t₁, and the outer shell 116 surrounding the inner shell 114 has a thickness t₂. The diameter d, thickness t₁, and thickness t₂ may be chosen to achieve the desired weight percent of the low melting temperature material. The diameter d of the core 112, as well as thicknesses t₁ and t₂ of the inner shell 114 and the outer shell 116, may be of any desired dimension.

Table 1 below provides several non-limiting examples wherein the core 112 is fabricated from copper or aluminum, the inner shell 114 is fabricated from nickel or silver, and the outer shell 116 is fabricated from tin. It should be understood that embodiments are not limited to the materials and thicknesses described in Table 1, and that other similar elements may be used in place of the elements described in Table 1.

TABLE 1

| Core | | Inner | | | Outer | Intermetallic compounds |
|---|---|---|---|---|---|---|
| Material | Diameter (um) | Material | Thickness (um) | Snwt % | Sn Thickness (um) | remelting temp (deg C.) |
| Cu or Al | 10 | Ni | 0.72 | 71.6 | 1.5 | 795 |
| | | | 0.73 | 73.0 | 1.6 | 795 |
| | | Ag | 3 | 26.8 | 0.8 | 480 |
| Cu or Al | 25 | Ni | 4.9 | 71.6 | 7.4 | 795 |
| | | | 4.9 | 73.0 | 7.8 | 795 |
| | | Ag | 6.9 | 26.8 | 1.9 | 480 |
| Cu or Al | 50 | Ni | 9.7 | 71.6 | 14.8 | 795 |
| | | | 9.7 | 73.0 | 15.6 | 795 |
| | | Ag | 13.8 | 26.8 | 3.8 | 480 |

In the examples provided in Table 1, the core 112 has a diameter d in a range of 10 μm and 50 μm, an inner shell 114 with a thickness t₁ in a range of 0.72 μm and 3 μm, and an outer shell 116 with a thickness t₂ in a range of 0.8 μm and 1.6 μm. It should be understood that these values are for illustrative purposes only. As shown in Table 1, the percent weight of tin affects the re-melting temperature of the intermetallic compounds of the resulting bond layer.

As stated above, the inclusion of a high melting temperature core 112 in the particles 110 described herein (e.g., copper or aluminum core) increases the ductility of the resulting bond layer over a transient liquid phase composition that includes only a high melting temperature material (e.g., nickel) and a low melting temperature (e.g., tin). Accordingly, the resulting bond layer has a ductility and re-melting temperature that may be desirable in power semiconductor applications, such as SiC semiconductor device applications, where there is a high operating temperature and a need for soft bond layers that will not fracture during operation.

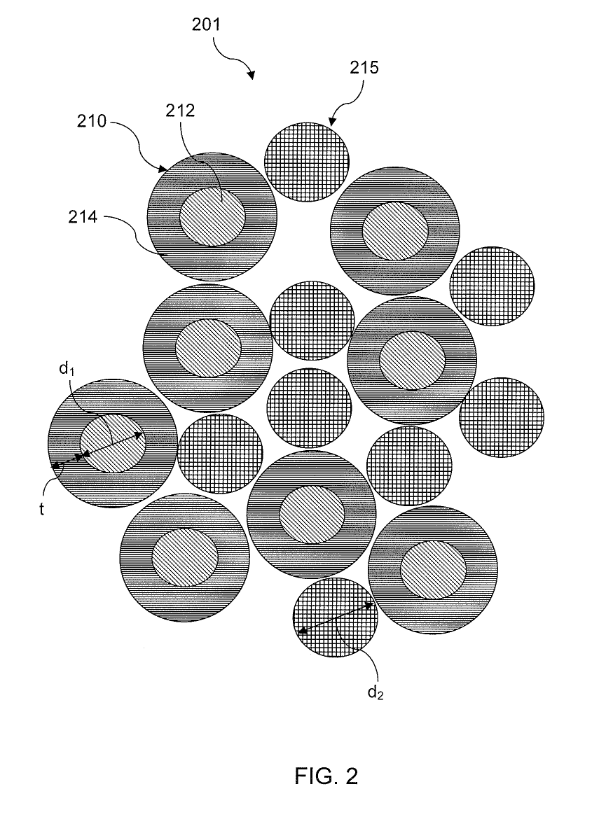

Referring now to FIG. 2, another transient liquid phase composition 201 is schematically illustrated. Similar to FIG. 1, a plurality of particles are depicted in a close-up, cross-sectional view. The example transient liquid phase composition 201 illustrated in FIG. 2 comprises a plurality of first particles 210 and a plurality of second particles 215. The plurality of first particles 210 are of a binary composition including a high melting temperature core 212 and a high melting temperature outer shell 214 surrounding the core 212. The outer shell 214 may be applied to the core 212 by any known or yet-to-be-developed technique. The second particles 215, which are dispersed amongst the first particles 210 in the example transient liquid phase composition 201, are made from a low melting temperature material having a melting temperature that is lower than the materials used for the core 212 and the outer shell 214 of the plurality of first particles 210. The first and second particles 210, 215 may be configured as a powder or, alternatively, as a paste comprising an organic binder.

As non-limiting examples, the first high melting temperature material of the core 212 may be nickel, silver, copper or aluminum, the second high melting temperature material of the outer shell 214 may be nickel or silver, and the low melting temperature of the plurality of second particles 215 may be tin or indium. As stated above with respect to the transient liquid phase composition 101 illustrated in FIG. 1, the percent weight of the low melting temperature material may be chosen to achieve a desirable re-melting temperature and ductility. The percent weight of the low melting temperature material may be achieved by appropriately selecting a diameter d₁ for the core 212, a thickness t for the outer shell 214, and a diameter d₂ of the second particles 215. A desirable percent weight of the low melting temperature may also be obtained by manipulating a ratio of the first particles 201 to the second particles 215.

As described above, the low melting temperature material of the plurality of second particles 215 diffuses into the high melting temperature material of the outer shell 214 of the plurality of first particles 210 during the transient liquid phase bonding process. The re-melting temperature of the resulting bond layer is greater than the initial melting temperature of the transient liquid phase composition 201.

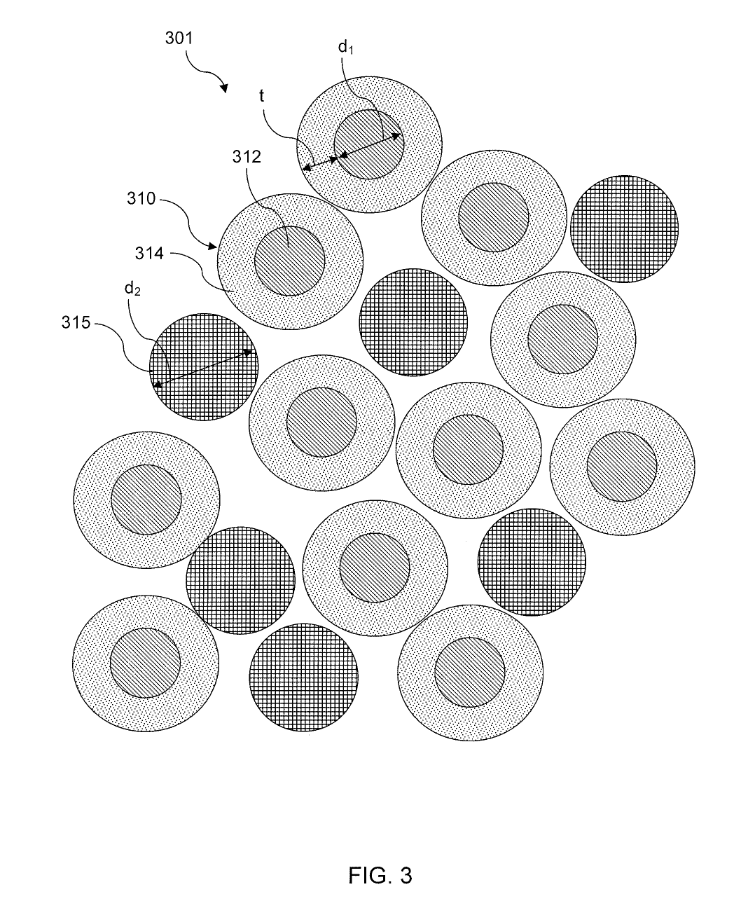

Referring now to FIG. 3, a close-up view of an example composition 301 is schematically depicted. The example composition 301 illustrated in FIG. 3 comprises a plurality of first particles 310 and a plurality of second particles 315. Each first particle 310 includes a high melting temperature core 312 of a diameter d₁ and a polymer outer shell 314 surrounding the core 312 of a thickness t. The polymer outer shell 314 may be any suitable polymer, such as a thermoplastic material. The polymer outer shell 314 may be applied to the core 312 by any known or yet-to-be-developed technique. The second particles 315, which have a diameter d₂ are dispersed amongst the first particles 315 in the example composition 301, are made from a low melting temperature material having a melting temperature that is lower than the material used for the core 312. The first and second particles 310, 315 may be loosely provided as a powder or, alternatively, as a paste comprising an organic binder.

Non-limiting example materials for the core include copper and aluminum, while non-limiting example materials for the second particles 315 include tin and indium.

During the bonding process, the increased temperature of the composition may cause the polymer outer shell 314 to transition from a liquid to a solid, which exposes the core 312 of at least a portion of the plurality of first particles 310 to be exposed to the plurality of second particles 315. The plurality of second particles 315 may diffuse into the core 312 during the bonding process. The presence of the polymer in the resulting bond layer may provide for a more compliant bond than a bond layer not including the polymer of the polymer outer shell 314. The composition 301 may be used as a bond layer for bonding a semiconductor device to a cooling device, for example.

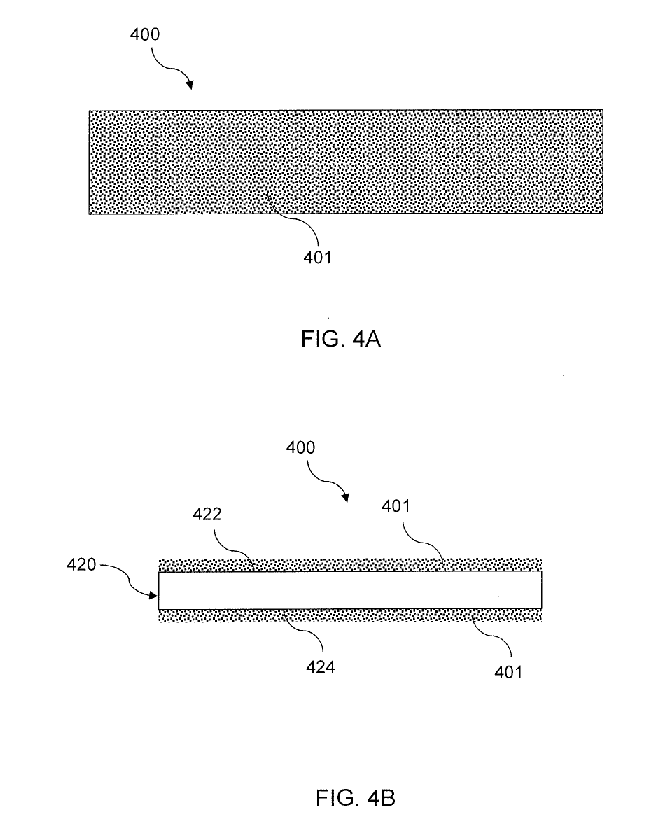

Referring now to FIGS. 4A and 4B, an example bonding assembly 400 comprising particles 401 embedded into surfaces of a metal foil 420 is schematically depicted. FIG. 4A is a top or bottom view of the bonding assembly 400, while FIG. 4B is a side view of the bonding assembly 400 depicted in FIG. 4A.

The metal foil 420 has a first surface 422 and a second surface 424. The metal foil comprises tin or other similar low melting temperature material such as indium. In some embodiments, the metal foil 420 is made from elemental tin or indium. In other embodiments, the metal foil is an alloy made from tin and/or indium, and may include other metals such as copper, nickel, silver, and aluminum. The metal foil 420 may be of any desired thickness. As a non-limiting example, the metal foil 420 may be between about 5 μm and about 100 μm thick.

The particles 401 may be configured as the ternary transient liquid phase particles 110 as described above with reference to FIG. 1, or as the first and second particles 210, 215 described above with reference to FIG. 2. Further, in some embodiments, the particles 401 may be configured as binary particles comprising a high melting temperature core (e.g., nickel, copper or silver) and a low melting temperature outer shell (e.g., tin or indium).

The particles 401 may be embedded into the first and/or second surfaces 422, 424 of the metal foil 420. Upon heating the bonding assembly 400, the low melting temperature material of the particles 401 and the metal foil 420 diffuses into the high melting temperature core of the particles 401 by a transient liquid phase process. The bonding assembly 400 may be used to form a bond layer between a power semiconductor device and a cooling assembly, for example. The re-melting temperature of the resulting bond layer is greater than the initial melting temperature of the bonding assembly 400.

The thickness of the layer(s) of particles 401 may be any appropriate thickness, and may depend on the desired percent weight of the low melting temperature material and the desired mechanical properties of the resulting bond layer.

The metal foil 420 may enable easy application of the bonding assembly 400 to a surface of one or more of the components to be bonded together.

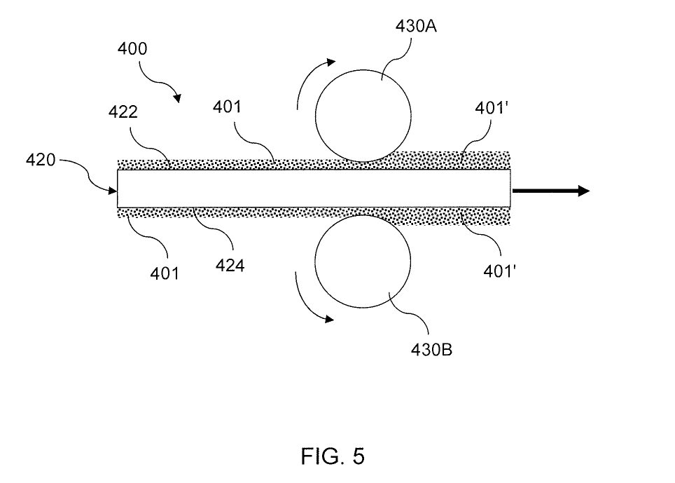

FIG. 5 schematically depicts an example process for embedding the particles 401 into the first and/or second surfaces 422, 424 of the metal foil 420. Particles 401′ are disposed in paste or loose powder form onto the first and/or second surfaces 422 of the metal foil 420. The metal foil 420 and particles 401′ are then passed through a roller assembly comprising two rollers 430A, 430B that compact and press the particles 401′ into the first and/or second surfaces 422, 424 of the metal foil 420, thereby forming a layer of compacted particles 401 on the first and/or second surfaces 422, 424 of the metal foil 420. The rollers 430A, 430B may be driven by one or more motors, for example.

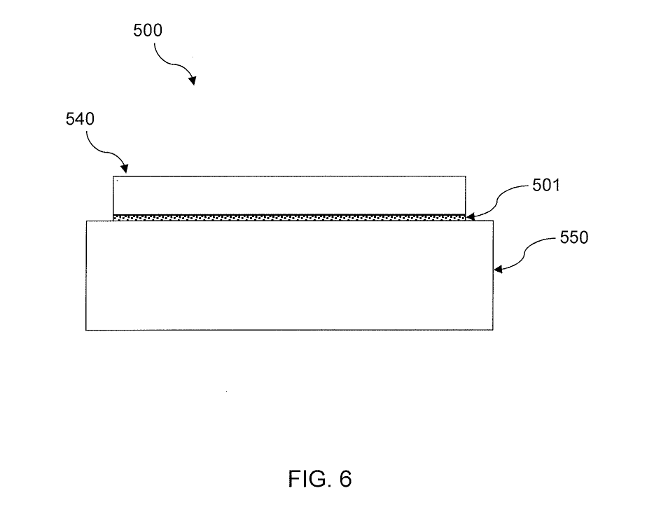

Referring now to FIG. 6, a power semiconductor device assembly 500 is schematically depicted. The assembly 500 comprises a power semiconductor device 540 (e.g., an insulated-gate bi-polar transistor, a metal-oxide-semiconductor field-effect transistor (“MOSFET”), silicon carbide-based semiconductor device (e.g., SiC MOSFET), and the like) that is bonded to a cooling assembly 550 by a bond layer 501. The cooling assembly 550 may be any component(s) configured to remove heat from the power semiconductor device 540, such as a heat sink, a heat spreader, a liquid-based cooler, and the like. The bond layer 501 may be fabricated from any of the particle-based compositions described herein. The bond layer 501 is capable of withstanding the high operating temperature of the power semiconductor device 540, while also being not as brittle as a bond formed by a traditional transient liquid phase process.

It should now be understood that embodiments described herein are directed to compositions comprising a plurality of particles that may be used to provide a high temperature bond between two components. In some embodiments, the particles include a high melting temperature core, a high melting temperature inner shell, and a low melting temperature outer shell. In other embodiments, a plurality of first particles includes first particles having a high melting temperature core surrounded by a high melting temperature shell, and a plurality of second particles made from a low melting temperature material. The material for the high melting temperature core is selected to tune the mechanical properties of the resulting bond layer to provide a more ductile bond. The resulting bond layer has a re-melt temperature that is higher than the initial melting temperature, and has a ductility that is greater than a bond layer without the second high melting temperature material of the core. The particles described herein may also be disposed in a metal foil prior to a transient liquid phase process.

In other embodiments, a composition comprises first particles including a high melting temperature core surrounded by a polymer shell, and second particles made of a low melting temperature material. The inclusion of the polymer shell allows for a more compliant bond layer than that of a traditional transient liquid phase bond.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

What is claimed is:

1. A transient liquid phase composition comprising a plurality of particles, each particle comprising:
a core comprising a first high melting temperature material;
an inner shell surrounding the core, the inner shell comprising a second high melting temperature material; and
an outer shell surrounding the inner shell, the outer shell comprising a low melting temperature material, wherein a melting point temperature of the low melting temperature material is less than a melting point temperature of both the first and second high melting temperature materials.

2. The transient liquid phase composition of claim 1, wherein the first high melting temperature material of the core is nickel, silver, copper, or aluminum.

3. The transient liquid phase composition of claim 1, wherein the second high melting temperature material of the inner shell is nickel or silver.

4. The transient liquid phase composition of claim 3, wherein the low melting temperature material of the outer shell is tin.

5. The transient liquid phase composition of claim 1, wherein the low melting temperature material of the outer shell is tin.

6. The transient liquid phase composition of claim 5, wherein a diameter of the core, a thickness of the inner shell, and a thickness of the outer shell are such that the transient liquid phase composition has a weight percent of tin between about 25% and about 75%.

7. The transient liquid phase composition of claim 1, wherein a diameter of the core is between about 10.0 μm and about 50.0 μm, a thickness of the inner shell is between about 0.7 μm and about 13.8 μm, and a thickness of the outer shell is between about 1.5 μm and about 15.6 μm.

8. The transient liquid phase composition of claim 1, wherein an initial melting temperature of the transient liquid phase composition is less than a re-melting temperature of the transient liquid phase composition.

9. The transient liquid phase composition of claim 1, further comprising a metal foil, wherein the plurality of particles is disposed in a surface of the metal foil.

10. The transient liquid phase composition of claim 9, wherein the metal foil comprises tin.

11. The transient liquid phase composition of claim 1, wherein the particles of the plurality of particles are substantially spherical.

12. A bonding assembly comprising:
a metal foil comprising a first surface and a second surface, wherein the metal foil comprises tin; and
a transient liquid phase composition comprising a plurality of particles disposed in the first surface and/or the second surface of the metal foil, each particle comprising:
a core comprising a first high melting temperature material, wherein the first high melting temperature material is nickel, silver, copper, or aluminum;
an inner shell surrounding the core, the inner shell comprising a second high melting temperature material, wherein the second high melting temperature material of the inner shell is nickel or silver; and
an outer shell surrounding the inner shell, wherein the outer shell is tin.

13. The bonding assembly of claim 12, wherein a diameter of the core, a thickness of the inner shell, and a thickness of the outer shell are such that the transient liquid phase composition has a weight percent of tin between about 25% and about 75%.

14. The bonding assembly of claim 12, wherein a diameter of the core is between about 10.0 μm and about 50.0 μm, a thickness of the inner shell is between about 0.7 μm and about 13.8 μm, and a thickness of the outer shell is between about 1.5 μm and about 15.6 μm.

15. The bonding assembly of claim 12, wherein an initial melting temperature of the transient liquid phase composition is less than a re-melting temperature of the transient liquid phase composition.

16. A composition comprising:
a plurality of first particles comprising:
a core comprising a first metal; and
a shell surrounding the core, wherein the shell comprises a polymer material; and
a plurality of second particles comprising a second metal, wherein a melting point temperature of the first metal is greater than a melting point temperature of the second metal.

17. The composition of claim 16, wherein the first metal of the core comprises aluminum or copper.

18. The composition of claim 16, wherein the second metal of the plurality of second particles comprises tin.

19. The composition of claim 16, wherein the polymer material of the shell comprises a thermoplastic material.

20. The composition of claim 16, wherein:
the first metal of the core comprises aluminum or copper;
the second metal of the plurality of second particles comprises tin; and
the polymer material of the shell comprises a thermoplastic material.
